(19) United States
(12) Patent Application Publication
(10) Pub. No.: US 2024/0329209 A1
(43) Pub. Date: Oct. 3, 2024

(54) MEASUREMENT APPARATUS

(71) Applicant: CANON KABUSHIKI KAISHA, Tokyo (JP)

(72) Inventors: TATSUYA KIMOTO, Tokyo (JP); TERUYUKI HIGASHIYAMA, Kanagawa (JP); MASATO ARAI, Tokyo (JP)

(21) Appl. No.: 18/582,820

(22) Filed: Feb. 21, 2024

(30) Foreign Application Priority Data
Mar. 29, 2023 (JP) 2023-052592

(51) Int. Cl. G01S 7/481; G01S 17/42

(52) U.S. Cl. CPC G01S 7/4817; G01S 17/42

(57) ABSTRACT

A measurement apparatus includes a mirror configured to irradiate an object with scanning light and to reflect reflected light from the object, a first driving unit configured to rotate the mirror about a first axis parallel to a horizontal direction, a second driving unit configured to rotate the mirror about a second axis parallel to a vertical direction, and a processor configured to control the first driving unit and the second driving unit and to acquire data on a shape of the object based on the reflected light. The processor acquires information about control of the second driving unit based on a lower limit value of a rotational speed of the second driving unit, which allows the second driving unit to rotate at a constant speed, and a target value of density of the data.

### BACKGROUND

### Technical Field

One of the aspects of the embodiments relates to a measurement apparatus configured to measure a shape of an object using scanning light.

### Description of Related Art

A laser radar apparatus using laser light, such as a so-called three-dimensional laser scanner, has conventionally been proposed. Japanese Patent Laid-Open No. 2017-156142 discloses a configuration that can acquire high-density point cloud data by setting a rotational speed of a mirror rotatable about a horizontal rotation axis and a vertical rotation axis. Japanese Patent Laid-Open No. 2017-166841 discloses a configuration that can acquire high-density point cloud data by repetitively turning on and off the driving of a motor and by rotating the mirror at a slow speed that exceeds the performance of the motor.

However, the configuration disclosed Japanese Patent Laid-Open No. 2017-156142 acquires point cloud data on the same scanning line, and thus causes part with high density and part with low density in the point cloud data. In the configuration disclosed in Japanese Patent Laid-Open No. 2017-166841, the mirror does not rotate at a constant speed, and the distances between adjacent point cloud data are not constant.

### SUMMARY

A measurement apparatus according to one aspect of the disclosure includes a mirror configured to irradiate an object with scanning light and to reflect reflected light from the object, a first driving unit configured to rotate the mirror about a first axis parallel to a horizontal direction, a second driving unit configured to rotate the mirror about a second axis parallel to a vertical direction, and a processor configured to control the first driving unit and the second driving unit and to acquire data on a shape of the object based on the reflected light. The processor acquires information about control of the second driving unit based on a lower limit value of a rotational speed of the second driving unit, which allows the second driving unit to rotate at a constant speed, and a target value of density of the data.

Further features of various embodiments of the disclosure will become apparent from the following description of embodiments with reference to the attached drawings.

### BRIEF DESCRIPTION OF THE DRAWINGS

FIG. 1 is a block diagram of a three-dimensional laser scanner that is an example of a measurement apparatus according to this embodiment.

FIG. 2 is a flowchart illustrating point cloud data acquisition processing according to Example 1.

FIG. 3 is a flowchart illustrating a method of acquiring information about control of a second motor in Example 1.

FIGS. 4A and 4B illustrate an example of scanning lines of point cloud data of Example 1.

FIGS. 5A and 5B illustrate an example of scanning lines of point cloud data of Example 1.

FIGS. 6A and 6B illustrate an example of scanning lines of point cloud data of Example 2.

FIGS. 7A and 7B illustrate an example of scanning lines of point cloud data of Example 2.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

### Example 1

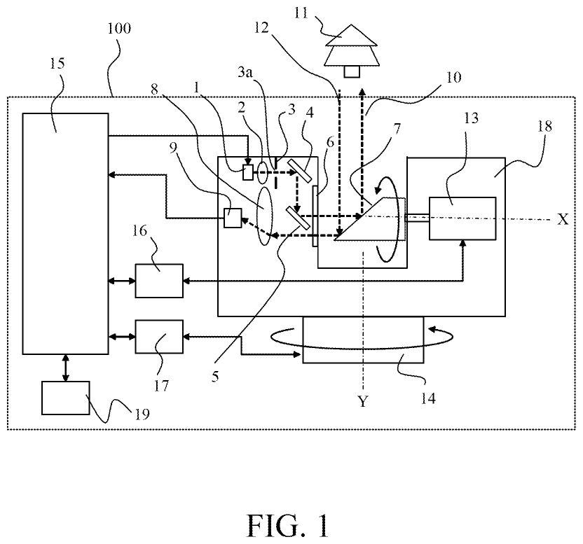

FIG. 1 is a block diagram of a three-dimensional laser scanner 100, which is an example of a measurement apparatus according to Example 1. The three-dimensional laser scanner 100 first irradiates an object (target) with a laser light (laser beam or scanning light) and measures a distance to the object using the reflected light reflected by the object. Next, the three-dimensional laser scanner 100 calculates coordinate values in the three-dimensional coordinate system by adding irradiation direction information of the laser beam to the measured distance. The three-dimensional laser scanner 100 acquires a plurality of coordinate values (point cloud data) by calculating three-dimensional coordinate values multiple times while changing the irradiation direction of the laser beam for the surrounding space. Finally, the three-dimensional laser scanner 100 measures the shape of the surrounding space using the acquired point cloud data.

The three-dimensional laser scanner 100 includes a semiconductor laser (light source) 1, a converging lens 2, a fixed aperture stop (diaphragm) 3, a first fixed mirror 4, a second fixed mirror 5, a protective glass 6, a rotatable mirror 7, a condenser lens 8, and a light receiving element 9. The three-dimensional laser scanner 100 further includes a first driving unit 13, a second driving unit 14, a control unit 15, a first motor driver 16, a second motor driver 17, a housing 18, and a memory 19.

The semiconductor laser 1 emits laser light 10. The converging lens 2 adjusts the beam shape of the laser light 10 in the target area to a desired shape. The fixed aperture stop 3 shields unnecessary light from the laser light 10. In this example, the semiconductor laser 1, the converging lens 2, and the fixed aperture stop 3 constitute a light emitter configured to irradiate the target area with the laser light 10.

The rotatable mirror 7 rotates about the X-axis (first axis parallel to the horizontal direction) and changes the irradiation direction of the laser light 10 along the vertical direction of the target area. The first driving unit 13 includes a first motor (first driving unit) and the like, and rotates the rotatable mirror 7 about the X-axis. The first motor has a first encoder configured to acquire information about the rotational position of the first motor. In this example, the rotatable mirror 7, the condenser lens 8, and the light receiving element 9 constitute a light receiver configured to receive reflected light and scattered light from the object within the target area.

The housing 18 holds the light emitter and the light receiver, rotates about the Y-axis (second axis parallel to the vertical direction), and changes the irradiation direction of the laser light 10 along the horizontal direction of the target area. The second driving unit 14 includes a second motor (second driving unit) and the like, and rotates the housing 18 about the Y-axis. The second motor includes a second encoder configured to acquire information about the rotational position of the second motor. In a case where the housing 18 rotates about an axis parallel to the horizontal direction, the rotatable mirror 7 also rotates about the Y-axis.

The control unit 15 controls the semiconductor laser 1, the light receiving element 9, the first driving unit 13, and the second driving unit 14. The control unit 15 includes a CPU as a computer and a memory as a memory (storage medium) for storing computer programs. The CPU is configured to control each component in the semiconductor laser 1, the light receiving element 9, the first driving unit 13, and the second driving unit 14 by executing the computer program in the memory.

The control unit 15 controls the semiconductor laser 1, the first driving unit 13, and the second driving unit 14 at predetermined driving voltages and driving frequencies, respectively. In order to irradiate the target area with the laser light 10 along the vertical direction, the control unit 15 controls the first driving unit 13 via the first motor driver 16, and in order to irradiate the target area with the laser light 10 along the horizontal direction, the control unit 15 controls the second driving unit 14 via the second motor driver 17.

The control unit 15 detects and stores the irradiation position of the semiconductor laser 1 in the vertical and horizontal directions.

The control unit 15 measures the received light waveform at a specific frequency while the light receiving element 9 receives light. The control unit 15 determines a difference between the light reception time obtained by the light receiving element 9 and the light emission time of the semiconductor laser 1, or a difference between a phase of the light receiving signal obtained by the light receiving element 9 and a phase of the output signal of the semiconductor laser 1, and acquires information about the distance to the object by multiplying the difference by the light speed.

The control unit 15, the first motor driver 16, and the second motor driver 17 may be built into the housing 18.

The memory 19 includes a nonvolatile memory such as EEPROM and flash memory. The nonvolatile memory stores setting values for each function included in the three-dimensional laser scanner 100.

The laser light 10 is projected from an aperture 3a in the fixed aperture stop 3, is reflected by the first fixed mirror 4 and the second fixed mirror 5, transmits through the protective glass 6, is reflected by the rotatable mirror 7, and is irradiated onto the target area. The laser light 10 irradiated onto the target area is guided to the rotatable mirror 7 as reflected light 12 from an object 11 within the target area. The reflected light 12 reflected by the rotatable mirror 7 passes through the protective glass 6, is guided to the condenser lens 8, and is received by the light receiving element 9.

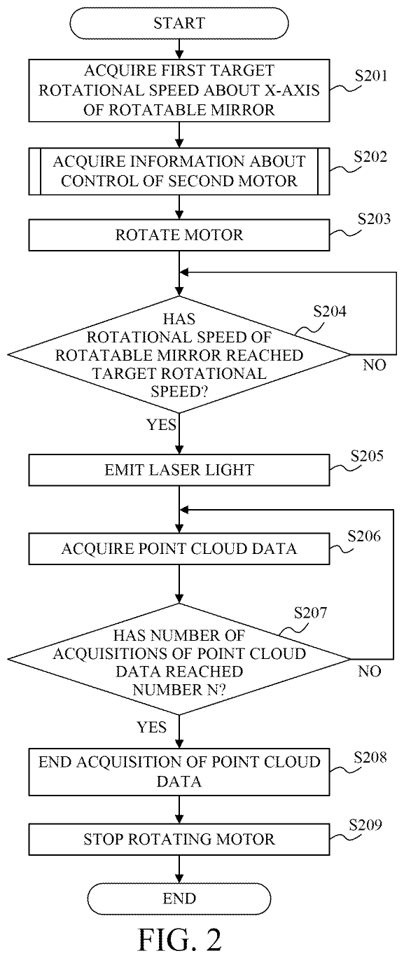

A description will be given of point cloud data acquisition processing according to this example. FIG. 2 is a flowchart illustrating the point cloud data acquisition processing. The flow in FIG. 2 is controlled by the CPU inside the control unit 15 executing the computer program in the memory, and started by the user of the three-dimensional laser scanner 100 using an unillustrated operation unit to the point cloud data acquisition processing.

In step S201, the control unit 15 acquires a first target rotational speed (unit: rpm, rotational speed of the first motor included in the first driving unit 13) about the X-axis of the rotatable mirror 7. The first target rotational speed is determined based on the density of the point cloud data required by the user of the three-dimensional laser scanner 100, and the higher the density is, the smaller the value (lower rotational speed) becomes. Assumed that the density of the point cloud data required by the user of the three-dimensional laser scanner 100 is previously stored in the memory 19 as a point cloud density target value D. The point cloud density target value D can be previously determined by the user of the three-dimensional laser scanner 100 selecting a desired mode from a plurality of modes with different measurement conditions (for example, a low density but high-speed mode and a high density but low-speed mode).

In step S202, the control unit 15 acquires information about the control of the second motor included in the second driving unit 14. The information about the control of the second motor includes at least one of the rotational speed of the second motor and the number of rotations by 180° (180 degrees) of the second motor. In this example, the control unit 15 acquires a second target rotational speed (rotational speed of the second motor) about the Y-axis of the rotatable mirror 7. This step also acquires the number N of acquisitions of point cloud data (the number of rotations by 180° of the second motor) by rotating the rotatable mirror 7 by 180° about the Y-axis (by rotating the second motor by) 180°. In this example, the rotatable mirror 7 rotates by 360° about the X-axis and by 180° about the Y-axis to acquire the point cloud data. Thereby, the point cloud data over the entire circumference of 360° can be acquired about the X-axis and the Y-axis. Thus, the rotation by 180° about the Y-axis of the rotatable mirror 7 is counted as one rotation.

In step S203, the control unit 15 rotates the first motor at the rotational speed acquired in step S201 via the first motor driver 16. The control unit 15 rotates the second motor at the rotational speed acquired in step S202 via the second motor driver 17. The control unit 15 executes the processing of this step, and thereby the rotatable mirror 7 rotates about the X-axis and the Y-axis.

In step S204, the control unit 15 determines whether the rotational speeds about the X-axis and the Y-axis of the rotatable mirror 7 have reached the first target rotational speed and the second target rotational speed, using the information acquired by the first encoder and the second encoder. In a case where the control unit 15 determines that the rotational speeds about the X-axis and the Y-axis of the rotatable mirror 7 have reached the first target rotational speed and the second target rotational speed, respectively, the control unit 15 executes the processing of step S205. In a case where the control unit 15 determines that the rotational speeds about the X-axis and the Y-axis of the rotatable mirror 7 have not reached the first target rotational speed and the second target rotational speed, respectively, the control unit 15 executes the processing of step S204.

In step S205, the control unit 15 controls the semiconductor laser 1 to emit the laser light 10.

In step S206, the control unit 15 first obtains information about the distance to the object using the above method. Next, the control unit 15 acquires point cloud data using information about the distance to the object and information acquired by the first encoder and the second encoder. Information about the distance to the object and information acquired by the first encoder and the second encoder are stored in the memory 19. This information may be stored in a storage medium removable from the three-dimensional laser scanner 100, such as an SD card. The user of the three-dimensional laser scanner 100 can refer to the stored values and specify the distance and direction to the object 11.

In step S207, the control unit 15 determines whether the number of acquisitions of the point cloud data has reached the number N by rotating the rotatable mirror 7 by 180° about the Y-axis. In a case where the control unit 15 determines that the number of acquisitions of point cloud data has reached the number N, the control unit 15 executes the processing of step S208. In a case where the control unit 15 determines that the number of acquisitions of point cloud data has not reached the number N, it executes the processing of step S206.

In step S208, the control unit 15 controls the semiconductor laser 1 to stop emitting the laser light 10, thereby ending the acquisition of the point cloud data.

In step S209, the control unit 15 stops rotating the first motor via the first motor driver 16, and stops rotating the second motor via the second motor driver 17.

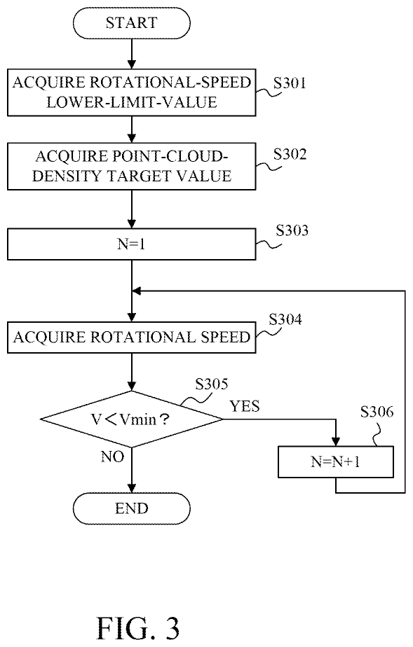

A description will now be given of a method for acquiring information about the control of the second motor in step S202 of FIG. 2. FIG. 3 is a flowchart illustrating the method for acquiring information about control of the second motor. The processing flow in FIG. 3 is controlled by the CPU inside the control unit 15 executing the computer program in the memory.

In step S301, the control unit 15 acquires the rotational-speed lower-limit-value Vmin from the memory 19. The rotational-speed lower-limit-value Vmin is determined based on the performance (characteristic) of the second motor, and is the lower limit value of the rotational speed at which the second driving unit 14 can stably rotate the rotatable mirror 7 at a constant speed. That is, the rotational-speed lower-limit-value Vmin is the lower limit value of the rotational speed of the second motor at which the second motor can rotate at a constant speed without causing cogging. The rotational-speed lower-limit-value Vmin may be a value that is uniquely determined with a margin at the shipping of the three-dimensional laser scanner 100, or may be a value that is updated according to environmental changes such as deterioration over time.

In step S302, the control unit 15 acquires point-cloud-density target-value D from the memory 19.

In step S303, the control unit 15 sets the number N of acquisitions of point cloud data by rotating the rotatable mirror 7 by 180° about the Y-axis to 1 as an initial value.

In step S304, the control unit 15 acquires the rotational speed V about the Y-axis of the rotatable mirror 7 (rotational speed of the second motor) for satisfying the point-cloud-density target-value D by the number N. The rotational speed Vis determined using the first target rotational speed determined in step S201, the point-cloud-density target-value D, and the number N. For example, in a case where the first target rotational speed is 360 rpm, the point-cloud-density target-value D is the density in a case where the rotatable mirror 7 is rotated 18,000 times about the X-axis, and the number Nis 1, the rotational speed Vis 0.01 rpm. In a case where the number N is 2, the rotational speed V is determined to be 0.02 rpm.

In step S305, the control unit 15 determines whether the rotational speed V is less than the rotational-speed lower-limit-value Vmin. The control unit 15 executes the processing of step S306 in a case where the rotational speed V is less than the rotational-speed lower-limit-value Vmin, and ends this flow in a case where the rotational speed V is not less than the rotational-speed lower-limit-value Vmin.

In step S306, the control unit 15 increments the number N by 1.

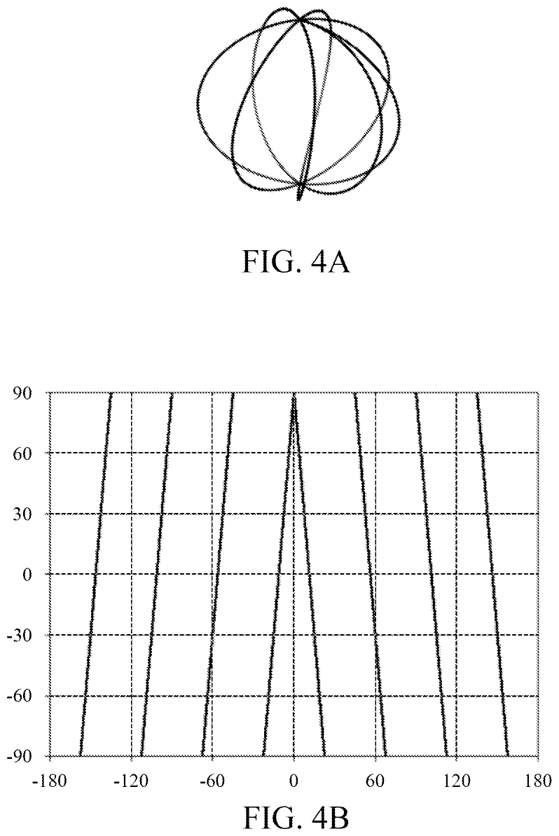

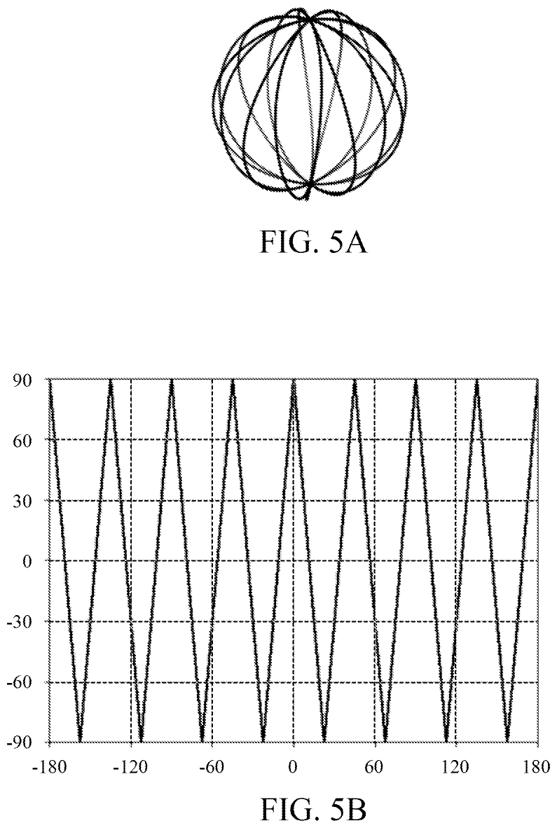

FIGS. 4A, 4B, 5A, and 5B illustrate examples of scanning lines of point cloud data acquired by the three-dimensional laser scanner 100 according to example.

FIGS. 4A and 4B represent an example of scanning lines in a case where the number N is determined to be 1 in step S202 of FIG. 2 (in a case where the rotatable mirror 7 is rotated by 360° about the Y-axis). FIG. 4A illustrates a pattern drawn by the scanning lines on a surface of a transparent virtual sphere that has an arbitrary radius and exists virtually around the rotatable mirror 7 where the rotatable mirror 7 is set as the center. FIG. 4B is a plane view that illustrates the scanning lines on the surface of the virtual sphere in FIG. 4A using the conformal cylindrical projection (Mercator projection). In FIG. 4B, similarly to a map, the longitude is expressed from −180° to 180° in the horizontal direction, and the latitude is expressed from −90° to 90° in the vertical direction.

FIGS. 5A and 5B represent an example of scanning lines in a case where the number N is determined to be 2 in step S202 of FIG. 2 (in a case where the rotatable mirror 7 is rotated by 360° about the Y-axis). Similarly to FIGS. 4A and 4B, FIG. 5A represents the scanning line in three-dimensional coordinates, and FIG. 5B represents the scanning line in a conformal cylindrical projection.

The configuration according to this example can increase the density of the point cloud data as the number N for rotating the rotatable mirror 7 by 180° about the Y-axis increases, as illustrated in FIGS. 4A, 4B, 5A, and 5B. Since the motor can be rotated at a constant speed, uneven distances in the point cloud data can be suppressed.

### Example 2

This example will describe a control method for acquiring point cloud data a plurality of times while the rotatable mirror 7 is rotated by 180° about the Y-axis and for preventing point cloud data acquired by this control from overlapping the scanning lines acquired by the past control.

The three-dimensional laser scanner according to this example has the same configuration as that of the three-dimensional laser scanner described in Example 1. This example will describe only the configuration different from that of Example 1, and will omit a description of the same configuration.

In the example described with reference to FIGS. 5A and 5B in Example 1, a ratio of the rotational speed about the X-axis of the rotatable mirror 7 and the rotational speed about the Y-axis of the rotatable mirror 7 is an integer, and thus the scanning lines in a case where the number Nis 3 overlap the scanning line in a case where the number Nis 1. Accordingly, in this example, in step S304 of FIG. 3, the control unit 15 acquires the rotational speed V about the Y-axis of the rotatable mirror 7 so that the ratio of the rotational speed about the X-axis of the rotatable mirror 7 to the rotational speed about the Y-axis of the rotatable mirror 7 is not an integer.

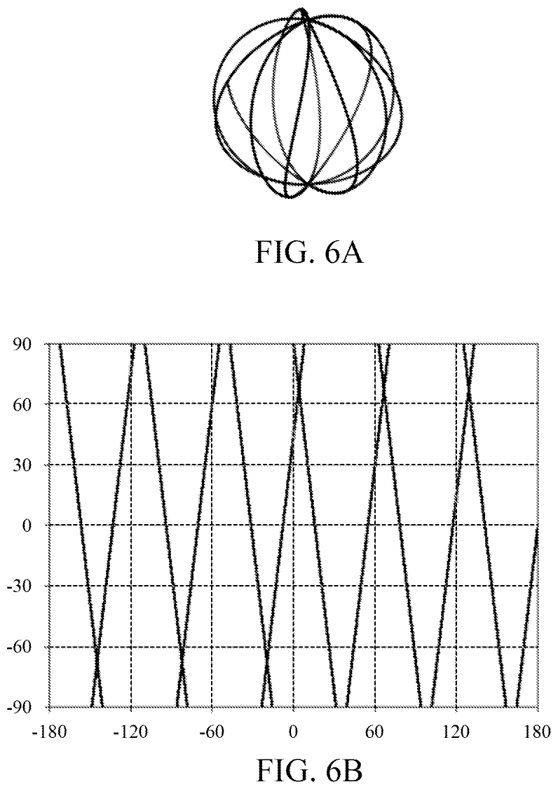

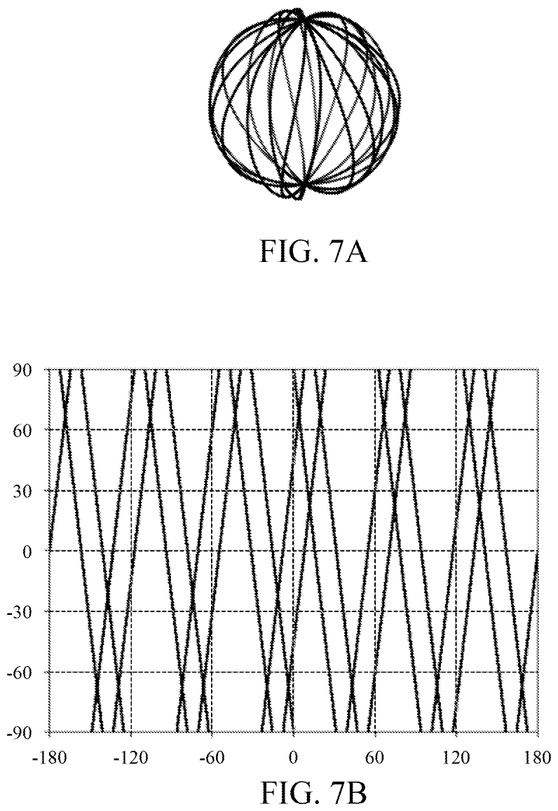

FIGS. 6A, 6B, 7A, and 7B illustrate examples of scanning lines of point cloud data acquired by the three-dimensional laser scanner 100 according to this example.

FIGS. 6A and 6B represent an example of scanning lines in a case where the number N is determined to be 1 in step S202 of FIG. 2 (in a case where the rotatable mirror 7 is rotated by 360° about the Y-axis). Similarly to FIGS. 4A and 4B, FIG. 6A represents the scanning lines in three-dimensional coordinates, and FIG. 6B represents the scanning lines in a conformal cylindrical projection.

FIGS. 7A and 7B represent an example of scanning lines in a case where the number N is determined to be 4 in step S202 of FIG. 2 (in a case where the rotatable mirror 7 is rotated by 720° about the Y-axis). Similarly to FIGS. 4A and 4B, FIG. 7A represents the scanning line in three-dimensional coordinates, and FIG. 7B represents the scanning line in a conformal cylindrical projection.

In addition to the effect of Example 1, as illustrated in FIGS. 6A, 6B, 7A, and 7B, as the number N of rotations by 180° about the Y-axis of the rotatable mirror 7 is increased, the configuration according to this example can increase the point cloud data density so that it does not overlap the scanning lines acquired in the past.

### OTHER EMBODIMENTS

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that some embodiments are not limited to the disclosed embodiments. The scope of the following claims is to be accorded the broadest interpretation so as to encompass all such modifications and equivalent structures and functions.

Each example can provide a measurement apparatus that can acquire point cloud data with high density and less uneven distances (intervals).

This application claims priority to Japanese Patent Application No. 2023-052592, which was filed on Mar. 29, 2023, and which is hereby incorporated by reference herein in its entirety.

What is claimed is:

1. A measurement apparatus comprising:
a mirror configured to irradiate an object with scanning light and to reflect reflected light from the object;
a first driving unit configured to rotate the mirror about a first axis parallel to a horizontal direction;
a second driving unit configured to rotate the mirror about a second axis parallel to a vertical direction; and
a processor configured to control the first driving unit and the second driving unit and to acquire data on a shape of the object based on the reflected light,
wherein the processor acquires information about control of the second driving unit based on a lower limit value of a rotational speed of the second driving unit, which allows the second driving unit to rotate at a constant speed, and a target value of density of the data.

2. The measurement apparatus according to claim 1, wherein the processor performs control to acquire the data while rotating the mirror about the first axis and rotating the mirror about the second axis by 180°, and
wherein the information about the control of the second driving unit includes at least one of the rotational speed of the second driving unit and the number of rotations by 180° of the second driving unit.

3. The measurement apparatus according to claim 1, wherein the lower limit value is determined based on a characteristic of the second driving unit.

4. The measurement apparatus according to claim 1, wherein the measurement apparatus has a plurality of modes with different measurement conditions, and
wherein the target value is determined based on one of the plurality of modes selected by a user.

5. The measurement apparatus according to claim 1, wherein the processor acquires the rotational speed of the second driving unit such that a ratio of the rotational speed of the second driving unit to a rotational speed of the first driving unit is not an integer.

6. The measurement apparatus according to claim 1, wherein in a case where the processor performs control a plurality of times to acquire the data while rotating the mirror about the first axis and rotating the mirror about the second axis by 180°, the processor acquires the rotational speed of the second driving unit such that a ratio of the rotational speed of the second driving unit to a rotational speed of the first driving unit is not an integer.
